(19) United States
(12) Patent Application Publication
(10) Pub. No.: US 2020/0116262 A1
(43) Pub. Date: Apr. 16, 2020

(54) EXHUAST VALVE

(71) Applicant: FAURECIA SYSTEMES D'ECHAPPEMENT, Nanterre (FR)

(72) Inventors: Raphael DE MATOS, SAONE (FR); Julien CAMBILLARD, BELFORT (FR); Francois LACOTURE, BESANCON (FR); Alen HALEPOVIC, SAINTE SUZANNE (FR); Francois THOMMELIN, SELIGNEY (FR)

(21) Appl. No.: 16/598,351

(22) Filed: Oct. 10, 2019

(30) Foreign Application Priority Data
Oct. 11, 2018 (FR) 18 59436

(51) Int. Cl. F16K 1/22; F16K 31/04

(52) U.S. Cl. CPC F16K 1/221; F16K 31/042

(57) ABSTRACT

An exhaust valve includes a body defining a passage section and extending along an extension axis from an upstream inlet able to be connected to an upstream pipe to a downstream outlet able to be connected to a downstream pipe. A flap is positioned in the body, across the passage section, and rotates around a rotation axis secant to the extension axis between a closed orientation where the flap closes the passage section and an open orientation where the flap frees the passage section. A transmission member is aligned along the rotation axis and is secured to the flap by a first end, and the second end of which is positioned outside the body. A rotating actuator drives the flap via the second end of the transmission member. A fastening element is used to fasten the actuator on the outside of the body (2). The valve further includes at least one fin positioned between the body and the actuator. Also, an exhaust line includes such a valve.

### CROSS-REFERENCE TO RELATED APPLICATIONS

This application is a U.S. non-provisional application claiming the benefit of French Application No. 18 59436, filed on Oct. 11, 2018, which is incorporated herein by its entirety.

### TECHNICAL FIELD

The present invention relates to an exhaust valve, able to be arranged on an exhaust line between an upstream pipe and a downstream pipe both conveying exhaust gases, and comprising a flap controllable so as to open or close the passage section of the pipe.

### BACKGROUND

The control of the flap is provided by an actuator, for example electric. According to one conventional embodiment, said actuator is arranged on the valve body.

The exhaust valve, due to its function, placing it near exhaust pipes, heated by the exhaust gases, is in a hot environment. This heat, which may reach several hundred degrees Celsius, is detrimental to the actuator, which typically withstands 170° C. It is therefore suitable to provide thermal protection for the actuator.

It is known to arrange a heat shield between the valve and the actuator. However, this solution is complex and expensive. Thus, an alternative solution is sought.

### SUMMARY

An exhaust valve includes a body defining a passage section and extending along an extension axis from an upstream inlet able to be connected to an upstream pipe to a downstream outlet able to be connected to a downstream pipe. A flap is positioned in the body, across the passage section, and rotates around a rotation axis secant to the extension axis between a closed orientation where the flap closes the passage section and an open orientation where the flap frees the passage section. A transmission member is aligned along the rotation axis and is secured to the flap by a first end, and the second end of which is positioned outside the body. A rotating actuator drives the flap via the second end of the transmission member. A fastening element is used to fasten the actuator on the outside of the body. The valve further comprises at least one fin positioned between the body and the actuator.

According to another feature, said at least one fin comprises at least one upstream fin arranged on the upstream side and at least one downstream fin arranged on the downstream side, said at least one upstream fin preferably being symmetrical to said at least one downstream fin.

According to another feature, said at least one fin has a longitudinal axis oriented, relative to the extension axis, along an angle of between 75 and 105°, preferably between 85 and 95°, and still more preferably equal to 90°.

According to another feature, said at least one fin comprises at least one part having an orientation around a longitudinal axis, relative to the extension axis, of between −45° and 60° and preferably between 0°, parallel to the extension axis, and 45°, right bisector of the angle between the extension axis and the rotation axis.

According to another feature, said at least one fin has an extension lengthwise, along the longitudinal axis, substantially equal to the extension of the body, along the longitudinal axis.

According to another feature, said at least one fin has an extension widthwise, along the extension axis, at least equal to 3 mm, preferably at least equal to 6 mm, and still more preferably at least equal to 10 mm.

According to another feature, said at least one fin is secured to the fastening element and is preferably integral therewith.

According to another feature, the body and the fastening element, including if applicable said at least one fin, are made integrally, preferably in two symmetrical parts, relative to a plane perpendicular to the extension axis, each part preferably comprising a stamped flange.

According to another feature, said at least one fin comprises at least two fins, substantially parallel and separated by a distance, along the rotation axis, at least equal to 3 mm and preferably at most equal to 5 mm.

The invention further relates to an exhaust line comprising such a valve.

### BRIEF DESCRIPTION OF THE DRAWINGS

Other features, details and advantages of the invention will emerge more clearly from the detailed description provided below, for information and in reference to the drawings, in which:

FIG. 1 is a cross-sectional view of one embodiment of a valve according to the invention,

FIG. 2 is a cross-sectional view of another embodiment of a valve according to the invention,

FIG. 3 is a perspective view of one embodiment of a valve according to the invention,

FIG. 4 is a perspective view of one embodiment of a valve according to the invention, illustrated without flap, without transmission member and without actuator,

FIG. 5 is a perspective view of a stamped flange forming a half-valve.

### DETAILED DESCRIPTION

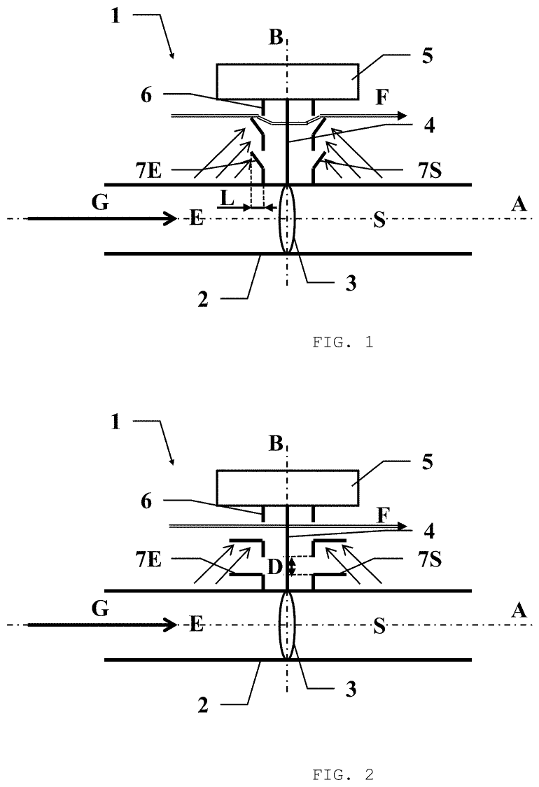

The invention relates to an exhaust valve 1. As illustrated in FIG. 1 or FIG. 3, according to another possible embodiment, such a valve 1 comprises a body 2. This body 2 is tubular, with any passage section, for example rectangular or circular, as illustrated. The body 2 extends along an extension axis A. The body 2 is completely closed, except for an inlet E and an outlet S. The inlet E is configured to be connected to an upstream pipe, which is why it is also called an upstream inlet. The term “upstream” describes everything related to a first side of the valve 1 located on the side of the inlet. The outlet S is configured to be connected to a downstream pipe, which is why it is also called a downstream outlet. The term “downstream” describes everything related to a second side of the valve 1 located on the side of the outlet. The exhaust gases flow according to a stream G, from the upstream pipe to the downstream pipe, while passing through the valve at the body 2. The extension axis A is the axis of a pipe formed by the upstream pipe, the body 2, and the downstream pipe.

The valve 1 further comprises a flap 3 arranged in the body 2, through the passage section, so as to be able to selectively close said passage section, at least partially, or to be able to free said passage section. To that end, the flap 3 advantageously has a substantially flat blank having a cross-section similar to the passage section and rotates, around a rotation axis B that is secant, advantageously perpendicular, to the extension axis A. The flap 3 can thus rotate from a closed orientation where the flap 3 closes the passage section and retains the exhaust gases and an open orientation where the flap 3 frees the passage section and allows the flow of the exhaust gases.

The rotation of the flap 3 is made possible by a transmission member 4 aligned with the rotation axis B. This transmission member 4 is secured to the flap 3 by a first end. The transmission member 4 passes through the wall of the body 2 such that its second end is arranged outside the body 2. Said transmission member 4 typically comprises a rigid shaft. It may further comprise any coupling element and, for example, comprises at least one element complying axially and/or angularly.

The valve 1 further comprises a rotating actuator 5, arranged outside the body 2. The outlet of the actuator 5 engages the second end of the transmission member 4 to drive the rotation of the flap 3 around the rotation axis B. Thus, a suitable command of the actuator 5 makes it possible to command the orientation of the flap 3.

The valve 1 further comprises a fastening element 6, making it possible to fasten the actuator 5 on the outside of the body 2.

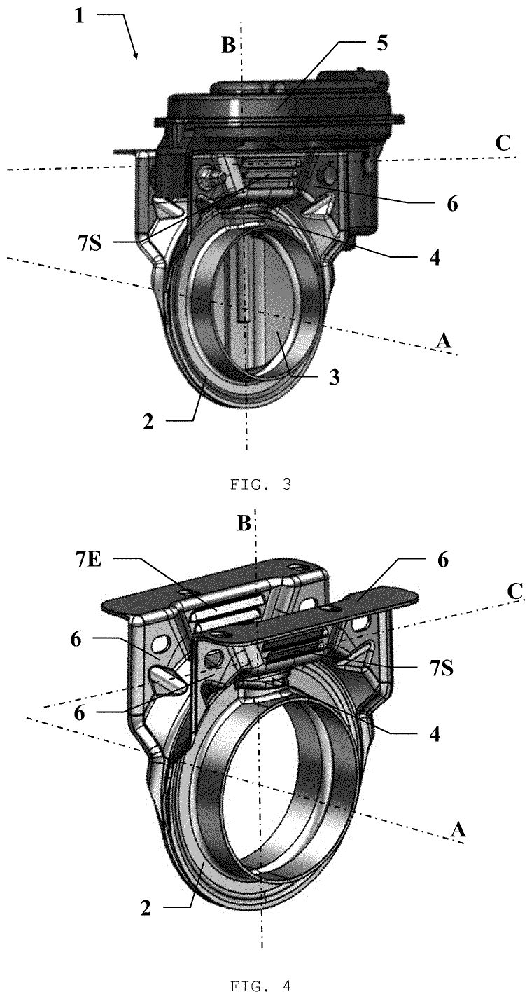

The actuator 5 is thus substantially aligned with the flap 3 and located, in position, not far from the flap 3, so as to be able to control its orientation without difficulty. This end, which is kinematically advantageous, is nevertheless thermally problematic. Indeed, the significant heat of the exhaust gases that circulate in the pipe formed by the upstream pipe, the body 2, and the downstream pipe, radiates from the pipe toward the actuator 5, as shown by the double or triple arrows in FIGS. 1 and 2.

Therefore, in order to block the path of this thermal radiation, according to one feature of the invention, the valve 1 further comprises at least one fin 7E, 7S, positioned between the body 2 and the actuator 5. Said at least one fin 7E, 7S is thus arranged on the path of the thermal radiation, and forms a heat shield, blocking or reducing said radiation and its effects.

In order to be between the body 2 and the actuator 5, a fin 7E, 7S is arranged substantially in a plane perpendicular to the rotation axis B, and therefore parallel to the extension axis A. In this plane, it is possible to arrange fins 7E, 7S along any orientation. However, due to the upstream and downstream pipes, there is one significantly hotter direction: along the extension axis A of the pipe. Therefore, preferably, said at least one fin 7E, 7S is preferably arranged above said pipe, or above the extension axis A.

The problem of thermal radiation is substantially symmetrical between the upstream and downstream directions. Therefore, the valve 1 advantageously comprises at least one upstream fin 7E arranged on the upstream side and at least one downstream fin 7S arranged on the downstream side. Said at least one upstream fin 7E is preferably symmetrical to said at least one downstream fin 7S. This symmetry is understood by shape, number, orientation and/or arrangement of the fins.

Said at least one fin 7E, 7S has a main extension along a longitudinal axis C. Said longitudinal axis C has, relative to the extension axis A, an orientation along an angle of between 75 and 105°, preferably between 85 and 95°, and still more preferably equal to 90°. In other words, the longitudinal axis C is preferably substantially perpendicular to the extension axis A. Thus, the fin(s) 7E, 7S are advantageously arranged in line with the upstream pipe and/or the downstream pipe, which are the source of the thermal radiation that one wishes to block.

Advantageously, said at least one fin 7E, 7S defines an opening in the body 2 of the same length along the longitudinal axis C.

It also follows that, according to such an arrangement, an air flow circulating between the fins 7E, 7S and contributing to cooling the transmission member 4 and the actuator 5 as described earlier, is aligned parallel to the pipe. It then advantageously follows, said pipe often being arranged along the longitudinal axis of a motor vehicle on which the valve 1 is mounted, that such an air flow F is naturally produced by the movement of the vehicle.

In a dual manner, said longitudinal axis C has, relative to the rotation axis B, an orientation along an angle of between 75 and 105°, preferably between 85 and 95°, and still more preferably equal to 90°. In other words, the longitudinal axis C is substantially perpendicular to the rotation axis B.

Said at least one fin 7E, 7S, as illustrated in FIGS. 1 and 2, can comprise several parts. An optional first part can be substantially planar and perpendicular to the extension axis A. One of the functions of this first part is to protect the transmission member 4 against any projections of stones, which may potentially be damaging.

A fin 7E, 7S comprises at least one inclined part. This part, which is advantageously substantially planar, has an orientation around the longitudinal axis C, relative to the extension axis A, of between 0° and 45°. The orientation 0°, as illustrated in FIG. 2, is parallel to the extension axis A. The orientation 45°, as illustrated in FIG. 1, is the bisector of the angle between the extension axis A and the rotation axis B. This inclined part is more particularly dedicated to the deflection of the thermal radiation.

The fins 7E, 7S thus perform a double deflection function of the thermal radiation, more particularly oriented from the pipe and the extension axis A toward the actuator 5, and thrown stones, more particularly oriented along a direction substantially parallel to the extension axis A, in order to protect the transmission member 4 and the actuator 5.

The extension lengthwise, or the extension along the longitudinal axis C, which is the larger extension axis, of a fin 7E, 7S is advantageously as large as possible to maximize the protective mechanical and thermal effect. Ideally, this length is equal to or exceeds the width of the pipe in line with the fin, or the width of the body 2, or the extension of the body 2 along the longitudinal axis C. In practice, as illustrated, the length of the fins 7E, 7S can be reduced so that the body 2 or the fastening element 6 does not have a width much larger than the width of the pipe.

The extension L widthwise, along the extension axis A, measured projected on said extension axis A, greatly determines the thermal efficiency of the fins 7E, 7S in order to block the thermal radiation. This extension is at least equal to 3 mm, preferably at least equal to 6 mm, and still more preferably at least equal to 10 mm. The larger this extension is, the greater the thermal efficiency is. A limitation of this extension L here can come from manufacturing constraints.

Said at least one fin 7E, 7S, which must be arranged between the body 2 and the actuator 5, is advantageously secured to the fastening element 6. It is preferably made to be integral with said fastening element 6.

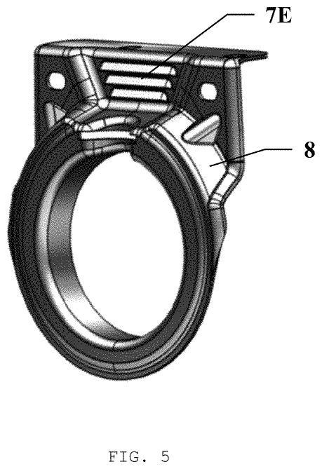

According to one embodiment, more particularly illustrated in FIGS. 3-5, the body 2, the fastening element 6 and, if applicable, said at least one fin 7E, 7S, are made to be integral, so as to reduce the number of components of the valve 1.

According to one preferred embodiment, taking advantage of the symmetry of the valve 1, said valve 1 is advantageously made in two parts 8 that are symmetrical relative to a plane perpendicular to the extension axis A. Such a valve 1 is then constructed by assembling said two parts 8 back to back.

According to one preferred embodiment, each of the two parts comprises a flange 8, more particularly illustrated in FIG. 5. This flange 8 is preferably made by stamping. It advantageously comprises a (half) body 2, a (half) fastening element 6, and (half) fins 7E. Two such flanges 8 are assembled back to back, for example by two screws parallel to the extension axis A, by gripping the flap 3 and its transmission member 4 between them. Each (half) fastening element 6 is advantageously completed by an upper (half) platen that is substantially perpendicular to the rotation axis B. The actuator 5 can be mounted on said platen.

Said at least one fin 7E, 7S can be unique. However, it advantageously comprises at least two fins, in order to increase the thermal and mechanical shield effect. Said at least two fins are substantially parallel and separated by a distance D, along the rotation axis B. This distance D is measured projected on the rotation axis B. The function of this distance D is to allow a circulation of an air flow F through the fins 7E, 7S. This air flow F, which is cooler, results in cooling the transmission member 4, the part of the actuator 5 facing the body 2, and more generally the entire interface area between the actuator 5 and the body 2. Said distance D may assume any value, including negative, depending on the incline of the fins 7E, 7S.

Preferably, the distance D is at least equal to 3 mm, in order to ensure an effective air flow F in terms of cooling. In order not to have too much vulnerability to projected gravel, said distance D is preferably equal to no more than 5 mm.

As previously indicated, the cooling action of the air flow F is optimal if it is aligned with the running direction of the vehicle and thus produced by the movement speed. If, which is most often the case, the extension axis A of the pipe is arranged in the running direction of the vehicle, the fins 7E, 7S are advantageously placed perpendicular to the extension axis A. If the pipe is arranged along another orientation, the fins 7E, 7S are rotated accordingly, such that they face the running direction.

The invention further relates to an exhaust line comprising such a valve, the valve for example, non-limitingly, being an exhaust gas recycling (EGR) valve, a back-pressure valve with cylinder deactivation or an acoustic valve.

Although an embodiment of this invention has been disclosed, a worker of ordinary skill in this art would recognize that certain modifications would come within the scope of this disclosure. For that reason, the following claims should be studied to determine the true scope and content of this disclosure.

1. An exhaust valve comprising:
a body defining a passage section and extending along an extension axis from an upstream inlet able to be connected to an upstream pipe to a downstream outlet able to be connected to a downstream pipe;
a flap positioned in the body, across the passage section, and rotating around a rotation axis secant to the extension axis between a closed orientation where the flap closes the passage section and an open orientation where the flap frees the passage section;
a transmission member aligned along the rotation axis and secured to the flap by a first end, and the second end of which is positioned outside the body;
a rotating actuator able to drive the flap via the second end of the transmission member;
a fastening element to fasten the rotating actuator on the outside of the body; and
at least one fin positioned between the body and the rotating actuator.

2. The exhaust valve according to claim Error! Reference source not found., where said at least one fin comprises at least one upstream fin arranged on an upstream side and at least one downstream fin arranged on a downstream side.

3. The exhaust valve according to claim 2, wherein said at least one upstream fin is symmetrical to said at least one downstream fin.

4. The exhaust valve according to claim 1, where said at least one fin has a longitudinal axis oriented, relative to the extension axis, along an angle of between 75 and 105°.

5. The exhaust valve according to claim 1, where said at least one fin has a longitudinal axis oriented, relative to the extension axis, along an angle of between 85 and 95.

6. The exhaust valve according to claim 1, where said at least one fin has a longitudinal axis oriented, relative to the extension axis, along an angle of 90°.

7. The exhaust valve according to claim 1, where said at least one fin comprises at least one part having an orientation around a longitudinal axis, relative to the extension axis, of between −45° and 60°.

8. The exhaust valve according to claim 1, where said at least one fin comprises at least one part having an orientation around a longitudinal axis, relative to the extension axis, of between 0°, parallel to the extension axis, and 45°, right bisector of an angle between the extension axis and the rotation axis.

9. The exhaust valve according to claim 1, where said at least one fin has an extension lengthwise, along the longitudinal axis, equal to the extension of the body, along the longitudinal axis.

10. The exhaust valve according to claim 1, where said at least one fin has an extension widthwise, along the extension axis, at least equal to 3 mm.

11. The exhaust valve according to claim 1, where said at least one fin has an extension widthwise, along the extension axis, at least equal to 6 mm.

12. The exhaust valve according to claim 1, where said at least one fin has an extension widthwise, along the extension axis, at least equal to 10 mm.

13. The exhaust valve according to claim 1, where said at least one fin is secured to the fastening element.

14. The exhaust valve according to claim 1, where said at least one fin is integral with the fastening element.

15. The exhaust valve according to claim 1, where the body and the fastening element, including if applicable said at least one fin, are made integrally.

16. The exhaust valve according to claim 15, wherein the body and the fastening element are made in two symmetrical parts, relative to a plane perpendicular to the extension axis.

17. The exhaust valve according to claim 15, wherein each symmetrical part comprises a stamped flange.

18. The exhaust valve according to claim 1, where said at least one fin comprises at least two fins, parallel and separated by a distance, along the rotation axis, at least equal to 3 mm.

19. The exhaust valve according to claim 1, where said at least one fin comprises at least two fins, parallel and separated by a distance, along the rotation axis, at most equal to 5 mm.

20. An exhaust line comprising an exhaust valve, the exhaust valve comprising:
a body defining a passage section and extending along an extension axis from an upstream inlet able to be connected to an upstream pipe to a downstream outlet able to be connected to a downstream pipe;
a flap positioned in the body, across the passage section, and rotating around a rotation axis secant to the extension axis between a closed orientation where the flap closes the passage section and an open orientation where the flap frees the passage section;
a transmission member aligned along the rotation axis and secured to the flap by a first end, and the second end of which is positioned outside the body;
a rotating actuator able to drive the flap via the second end of the transmission member,
a fastening element to fasten the rotating actuator on the outside of the body; and
wherein the exhaust valve further comprises at least one fin positioned between the body and the rotating actuator.
